(19) United States
(12) Patent Application Publication
(10) Pub. No.: US 2011/0047809 A1
(43) Pub. Date: Mar. 3, 2011

(54) Laundry treating system

(76) Inventor: Jong Sun YOON, Changwon-si (KR)

(21) Appl. No.: 12/805,799

(22) Filed: Aug. 19, 2010

(30) Foreign Application Priority Data
Aug. 28, 2009 (KR) 10-2009-0080482

(51) Int. Cl. F26B 25/08

(52) U.S. Cl. 34/239

(57) ABSTRACT

A laundry treating system is disclosed. The laundry treating system includes a first treating device configured to wash and/or dry laundry, a second treating device installed next to the first treating device side by side and configured to wash and/or dry laundry, and a work table installed on top portions of the first and second treating devices to form a predetermined space for works relating the laundry, the work table configured not to move in a forward direction of the first and second treating devices.

### CROSS REFERENCE TO RELATED APPLICATION

This application claims the benefit of the Patent Korean Application No. 10-2009-0080482, filed on Aug. 28, 2009, which is hereby incorporated by reference as if fully set forth herein.

### BACKGROUND OF THE DISCLOSURE

1. Field of the Disclosure

The present invention relates to a laundry treating system which can wash and/or dry laundry items.

2. Discussion of the Related Art

Well-known in the art the present invention pertains to, washing machines and dryers provide a complementary function to each other and they are often installed side by side as the case may be. Because of that, recently, a laundry treating system combined by such independent washing machine and dryer as a set has been commercialized. The laundry treating system is fabricated, with the washing machine and dryer connected with each other structurally and functionally. Such the laundry treating system may be configured of a pair of washing machines or dryers and the laundry treating system may include a washing machine having a drying function. In addition, the laundry treating system may have a single unified design to be recognized as single system by a user.

The laundry treating system may implement processes relating to laundry at a time, only to bring efficiency and convenience to the user. However, to enhance the efficiency and convenience, the structure of the laundry treating system is required to be improved continuously.

### SUMMARY OF THE DISCLOSURE

Accordingly, the present invention is directed to a laundry treating system.

An object of the present invention is to provide a laundry treating system having enhanced efficiency and convenience.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a laundry treating system includes a first treating device configured to wash and/or dry laundry; a second treating device installed next to the first treating device side by side and configured to wash and/or dry laundry, the second treating device separately independent from the first treating device; and a work table installed on top portions of the first and second treating devices to form a predetermined space for works relating the laundry, the work table configured not to move in a forward direction of the first and second treating devices.

Each of the first and second treating devices may comprise any one of a washing machine, a dryer or a washing machine having a drying function.

The work table may include a body comprising a plate-shaped member extended over top surfaces of the first and second treating devices.

The work table may include an upper flange extended upward along an edge portion of the body.

The work table may include first lower flanges extended downward from both opposite side portions of the body.

The first lower flanges may be spaced apart a predetermined distance from side surfaces of the first and second treating devices adjacent thereto.

The distance between the first lower flanges and the side surfaces of the first and second treating devices adjacent to the first lower flanges, respectively, may be 8 mm.

The work table may include a second lower flange extended downward from a rear portion of the body. The second lower flange could be in contact with rear surfaces of the first and second treating devices, such that the work table is not allowed to move forward. The second lower flange may include a buffering member disposed between the first and second treating devices and the second lower flange. The second lower flange may be configured not to interfere with accessories installed in rear surfaces of the first and second treating devices. Preferably, the second lower flange may include a cut-away portion configured to seat the accessories installed in the rear surfaces of the first and second devices therein.

The work table may include a spacer inserted between the first and second treating devices to maintain a predetermined gap formed between the first and second devices, the spacer extended downward from the body of the work table. The gap between the first and second treating devices may be 25 mm.

According to the laundry treating system of the present invention, the work table is provided to allow a user to perform works relating to the laundry. Such the work table is configured not to move in any directions for the user to perform the works relating to the laundry. As a result, the user may utilize the laundry treating system more efficiently and conveniently because of the present invention.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a front view illustrating a laundry treating system according to an exemplary embodiment of the present invention;

FIG. 2 is a perspective view illustrating a top surface of a work table provided in the laundry treating system;

FIG. 3 is a perspective view illustrating a bottom surface of the work table provided in the laundry treating system; and

FIGS. 4 to 6 are front, side and rear views illustrating the work table of the laundry treating system, respectively.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

As follows, a laundry treating system according to the present invention and a control method thereof will be described in reference to the accompanying drawings.

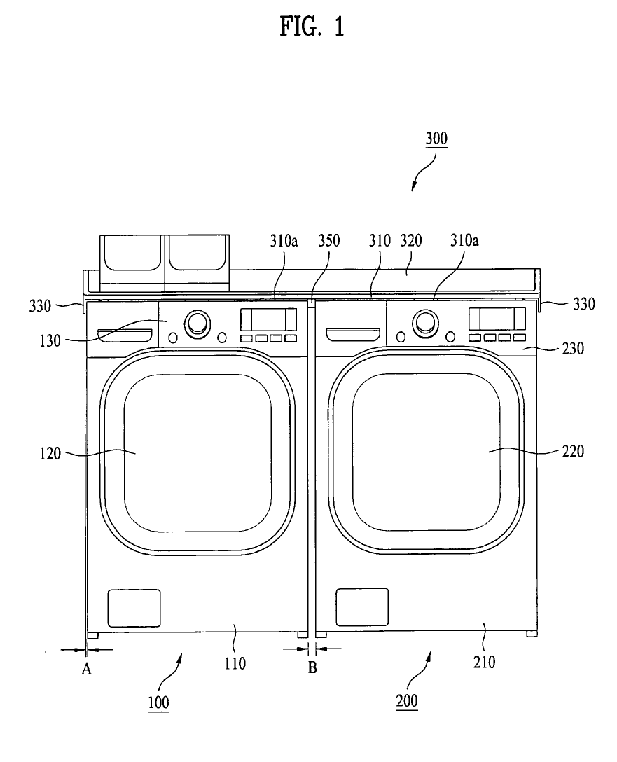

FIG. 1 is a front view illustrating a laundry treating system according to an exemplary embodiment of the present invention.

As shown in FIG. 1, the laundry treating system comprises a single set of a first treating device 100 and a second treating device 200. As shown in FIG. 1, the first and second treating devices 100 and 200 have independent and separate structures, respectively, and they are combined to form the laundry treating system. The first and second treating devices 100 and 200 may be designed with a similar size, to have a design unity.

Such the first and second treating devices 100 and 200 may be washing machines, dryers or washing machines having a drying function. The first and second treating devices 100 and 200 include housings 110 and 210 configured to define exterior appearances thereof, respectively. A variety of inner parts required to operate the devices may be installed in the housings 110 and 210. Doors 120 and 220 are coupled to the housings 110 and 210, respectively, to allow laundry loaded into the first and second devices 100 and 200. To control the overall operation, control panels 130 and 230 are provided in the housings 110 and 220, respectively. Specifically, the first or second treating device 100 or 200 comprises a washing machine. A tub is mounted in the housing 110 or 210 to hold wash water therein and a drum is rotatably installed in the tub to accommodate and wash the laundry. In addition, a driving mechanism configured to rotate the drum is provided in the housing 110 or 210. If the first or second treating device 100 or 200 comprises a dryer, a duct and a heating device which are configured to supply hot air to the drum may be additionally provided in the housing 110 or 210, together with the configuration described above. In case the first or second treating device 100 or 200 comprises the dryer, the drum is rotatably installed in the housing 110 or 210 to accommodate and dry laundry and a heating device and a duct structure configured to supply hot air to the drum inside may be provided. Such the first and second laundry treating devices 100 and 200 may include independent control units, respectively, or a single control unit configured to control the first and second laundry treating devices 100 and 200 simultaneously, to simplify the overall structure and to reduce the production cost. This single control unit may be installed one of the first and second laundry treating devices 100 and 200.

According to the laundry treating system shown in FIG. 1, the first and second treating devices 100 and 200 may be arranged side by side to perform a variety of operations closely related with each other. Because of that, a user may have easy access to the laundry treating system conveniently and he/she can treat an overall washing process conveniently at a time. That is, if the first treating device 100 is a washing machine and the second treating device 200 is a dryer, the user operates the first treating device 100 to wash laundry and then he/she unloads the laundry. After that, the user operates the second treating device 200 to dry the washed laundry. As a result, the washing process which starts in the first treating device 100 may be completed in the second treating device 100 without stopping. Preferably, the first and second treating devices 100 and 200 provided in the single laundry treating system may be designed to have the identical height and width to unify the overall design as well as the function, as shown in FIG. 1.

Such the laundry treating system is typically installed in a laundry room of a household and this laundry room is typically not so large, such that it is inconvenient for the user to use the laundry room in implementing works relating to the laundry. Even if the laundry room is quite large, the works relating to the laundry will be performed near the laundry treating system and it is preferable for convenience sake that the laundry treating system has a predetermined space for the works relating to the laundry. As described above, the first and second treating devices 100 and 200 provided in the laundry treating system are arranged side by side. Because of that, top surfaces of the devices are connected with each other and quite a large single surface is formed accordingly. As shown in FIG. 1, a work table 300 is installed on top portions of the first and second treating devices 100 and 200. Since the first and second treating devices 100 and 200 have a connected large top surface, the work table 300 installed on the top surfaces may provide the user with enough space for the work relating to the laundry. As a result, the user may put laundry items washed or to be washed on the work table 300 temporarily and he/she may fold the work table in a predetermined size proper to hold the laundry items. In addition, detergent, fabric softener used in washing and tools may be placed on the work table 300 and the user may use them whenever the need arises. Because of that, the work table 300 may improve user convenience and washing efficiency and it will be described specifically in reference to a corresponding drawing, as follows.

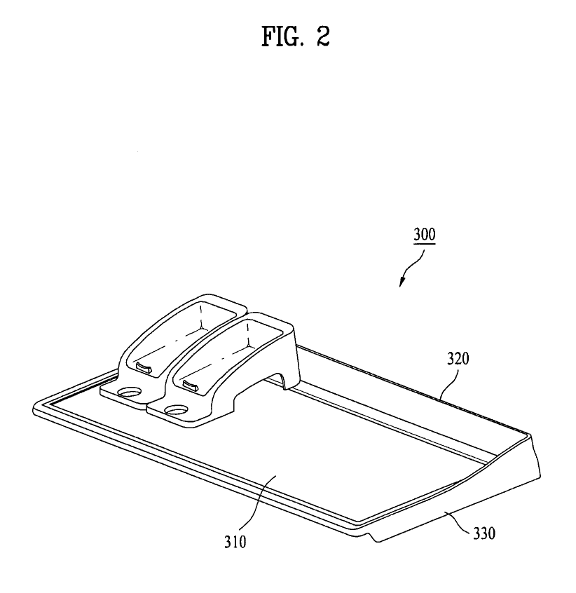

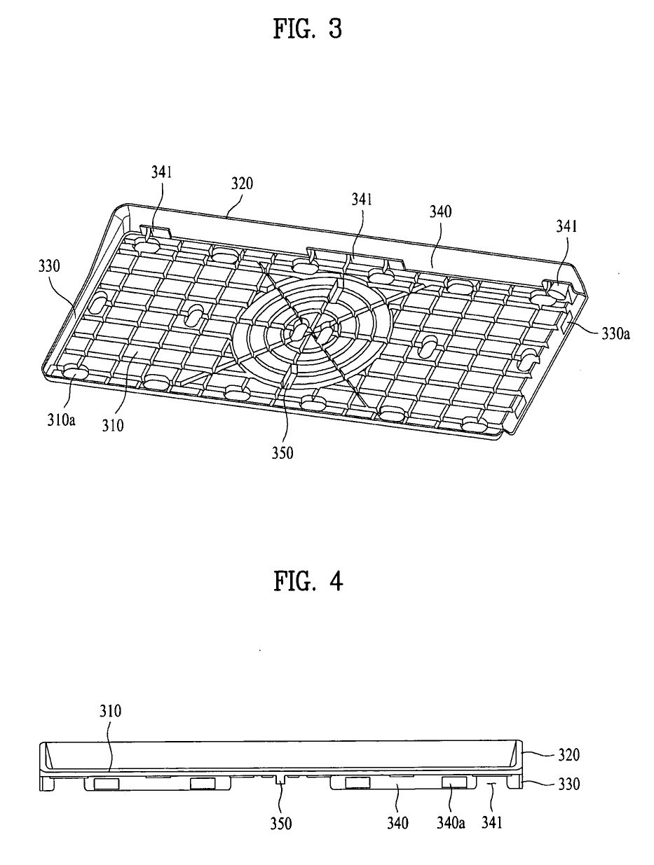

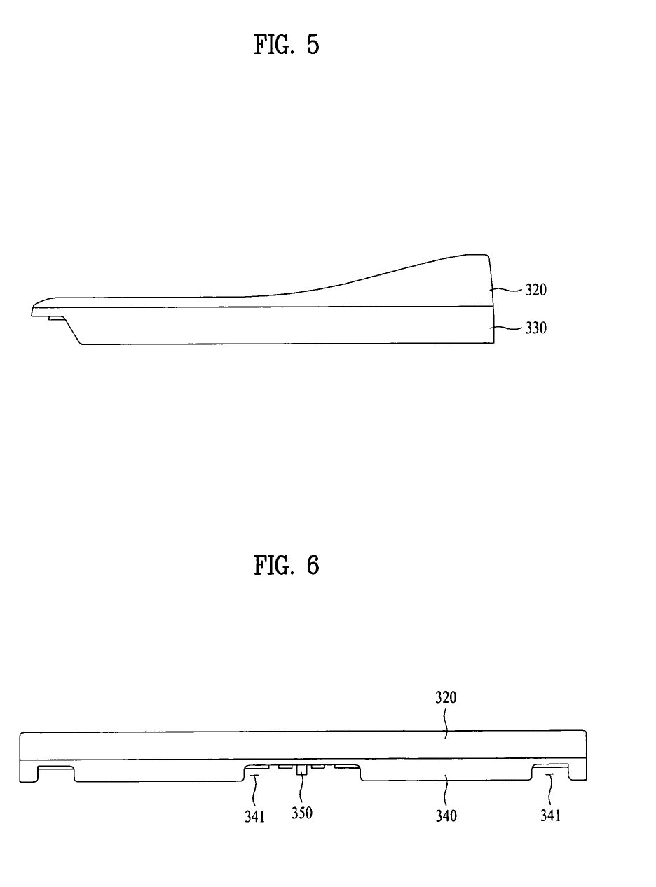

FIG. 2 is a perspective view illustrating a top surface of a work table provided in the laundry treating system. FIG. 3 is a perspective view illustrating a bottom surface of the work table provided in the laundry treating system. FIGS. 4 to 6 are front, side and rear views illustrating the work table of the laundry treating system, respectively.

The work table 300 includes a body 310 basically and the body 310 is a plate-shaped member extended over the top portions of the first and second treating devices 100 and 200, to define a predetermined space for the work relating to the laundry substantially. The body 310 may be installed in direct contact with the top portions. However, much vibration would be generated during the operations of the first and second treating devices 100 and 200 and this vibration would be transmitted to the body 310 directly. In this case, the objects placed on the body 310 happen to fall and friction and noise might be generated between the body 310 and the top portions. As a result, a plurality of buffering members 310a may be provided on a bottom surface of the body 310 and the buffering members 310a may be disposed between the body 310 and the top surfaces of the first and second treating devices 100 and 200 to prevent the bottom surface from contacting with the top surfaces directly. Also, the buffering members 310a may absorb the vibration transmitted from the first and second treating devices 100 and 200 and they may prevent the transmission of vibration, abrasion generated by the vibration and the noise effectively.

The work table 300 includes an upper flange extended upward from the body 310. The upper flange 320 is extended along an edge of the body 310 and the objects placed on the body 310 may be prevented from escaping the work table 300. However, the upper flange 320 may be formed along the edge portions of both opposite sides and back sides of the body 310, not of a front side.

The work table 300 may include first lower flanges 330 extended downward from the both sides of the body 310. As more specifically shown in FIGS. 3 and 4, the first lower flanges 330 may be extended downward from both side edges of a bottom surface of the body 310. While the user is performing various works on the work table 300, a predetermined sized force is applied to the work table 300 and the work table 300 can be moved on the top portions of the first and second treating devices 100 and 200. Because of that, the user cannot perform the working on the work table 300 securely. As the first lower flanges 330 are extended downward by the predetermined length as described above, the first lower flanges 330 securely latch on side portions of the first and second treating devices 100 and 200. As a result, the rightward and leftward movement of the work table 300 may be limited by the first lower flanges 330 and the work table 300 is kept on the first and second treating devices 100 and 200 securely.

The first lower flanges 330 may be formed in close contact with the side portions of the first and second treating devices 100 and 200. In this case, the first lower flanges 330 may allow no rightward/leftward movement of the work table 300. however, the widths of the first and second treating devices 100 and 200 have a predetermined permissible error tolerance and the overall width of the first and second treating devices 100 and 200 arranged side by side, which is the width of the laundry treating system, may be variable in the range of the permissible tolerance. Moreover, the width formed by the combination of the first and second treating devices may be influenced by an installation place and other conditions of the laundry treating system. Considering such the variable width of the laundry treating system, it will be difficult to install the work table 300 on the first and second treating deices 100 and 200 if the first lower flanges 330 are designed in close contact with the side surfaces of the devices without any permissible tolerance. Because of that, it is preferable that the first lower flanges 330 are designed to be spaced apart a predetermined distance from the side surfaces of the first and second treating devices 100 and 200. That is, considering the permissible tolerance of the width of the laundry treating system, the distance between the first lower flanges 330 may be preset larger than the entire width of the laundry treating system. As more specifically shown in FIG. 1, the gap (A) means the distance between an inner surface of the first lower flange 330 facing the side surface of the first or second treating device 100 or 200 and the side surface of the first or second treating device 100 or 200 adjacent to such first lower flange 330. it is preferable that the gap (A) may be preset to be 8 mm. Like the buffering members 310a described above, buffering members 330a may be provided between the first lower flanges 330 and the side surfaces of the first and second treating devices adjacent thereto, to prevent abrasion and noise which might be generated by the vibration.

The laundry treating system is installed with a rear surface thereof, which is close to a wall of the installation place. Because of that, the wall of the building could limit rearward movement of the work table 300, but there is no auxiliary structure configured to limit forward movement of the work table 300. To limit the forward movement of the work table 300, the work table 300 may include second lower flanges 340 extended downward from a rear edge of the body 310. More specifically, the second lower flanges 340 are extended downward from a rear edge of the bottom surface of the body 310 as shown in FIGS. 4 to 6. The second lower flanges 340 are extended downward by a predetermined length and they securely latch on rear surfaces of the first and second treating devices 100 and 200. As a result, the forward movement of the work table 300 may be limited by the second lower flanges 340 and the work table 300 may be arranged more securely on the first and second treating devices 100 and 200 without substantial movement in any the directions, due to the first and second lower flanges 330 and 340.

As described above, since the rearward movement of the work table 300 is limited by the wall of the building, no members like the second lower flanges 340 may be provided in a front portion of the work table 300. Because of that, the second lower flanges 340 may be designed without consideration of a permissible tolerance of the depth, which is the distance between front and rear ends of the first and second treating devices 100 and 200. As a result, the second lower flanges 340 could be formed in close contact with the rear surfaces of the first and second treating devices 100 and 200. Such the second lower flanges 340 may not allow any forward movement of the work table 300, and could be advantageous in the secure arrangement of the work table 300. Nevertheless, if necessary, buffering members 340a like the buffering members 320a and 330a may be provided between the second lower flanges 340 and the rear surfaces of the first and second treating devices 100 and 200 adjacent to the second lower flanges, as shown in FIG. 4, to prevent the abrasion and noise generated by the vibration.

Typically, a variety of accessories may be installed in the rear surfaces of the first and second treating devices 100 and 200. For example, handles used to transmit the first and second treating devices, a power code assembly and the like may be installed as accessories. The second lower flanges 340 may be extended downward from the rear portion of the work table 300 and they may interfere with the above parts. Therefore, as shown in FIGS. 4 to 6, the second lower flanges 340 may include cut-away portions. The cut-away portions 341 may form predetermined seating spaces to seat the accessories therein such that the second lower flanges 340 may not interfere with the accessories.

In addition, if the first and second treating devices 100 and 200 are in close contact with each other, the vibration generated during the operation of the devices may cause friction between wall surfaces of the first and second treating devices 100 and 200 adjacent to each other and the friction may generate noise accordingly. Accordingly, it is required to install the first and second treating devices 100 and 200 spaced apart a predetermined distance from each other. For that reason, the work table 300 may include a spacer 350 extended downward from the body as shown in FIGS. 1, 3, 4 and 5. More specifically, such the spacer 350 may be extended from the bottom surface of the body 310, arranged along a center line of the bottom surface. The spacer 350 may be inserted between the first and second treating devices 100 and 200 and the predetermined distance between the first and second treating devices 100 and 200 may be maintained, accordingly, as shown in FIG. 1. A gap (B) indicates the distance maintained between the first and second treating devices 100 and 200 by the spacer 350 and the gap (B) may be preset to be 25 mm.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry treating system comprising:
a first treating device configured to wash and/or dry laundry;
a second treating device installed next to the first treating device side by side and configured to wash and/or dry laundry, the second treating device separate from the first treating device; and
a work table installed on top portions of the first and second treating devices to form a predetermined space for works relating the laundry, the work table configured not to move in a forward direction of the first and second treating devices.

2. The laundry treating system of claim 1, wherein each of the first and second treating devices comprising any one of a washing machine, a dryer or a washing machine having a drying function.

3. The laundry treating system of claim 1, wherein the work table has a body comprising a plate-shaped member extended over top surfaces of the first and second treating devices.

4. The laundry treating system of claim 1, wherein the work table comprises an upper flange extended upward along an edge portion of a body thereof.

5. The laundry treating system of claim 1, wherein the work table comprises first lower flanges extended downward from both opposite side portions of a body thereof.

6. The laundry treating system of claim 5, wherein the first lower flanges are spaced apart with a predetermined distance from side surfaces of the first and second treating devices adjacent thereto.

7. The laundry treating system of claim 6, wherein the distance between the first lower flanges and the side surfaces of the first and second treating devices adjacent to the first lower flanges, respectively, is 8 mm.

8. The laundry treating system of claim 1, wherein the work table comprises a second lower flange extended downward from a rear portion of a body thereof.

9. The laundry treating system of claim 8, wherein the second lower flange is in contact with rear surfaces of the first and second treating devices, such that the work table is not allowed to move forward.

10. The laundry treating system of claim 8, wherein the second lower flange includes a buffering member disposed between the first and second treating devices and the second lower flange.

11. The laundry treating system of claim 8, wherein the second lower flange is configured not to interfere with accessories installed in rear surfaces of the first and second treating devices.

12. The laundry treating system of claim 11, wherein the second lower flange comprises a cut-away portion configured to seat the accessories installed in the rear surfaces of the first and second devices therein.

13. The laundry treating system of claim 1, wherein the work table comprises a spacer inserted between the first and second treating devices to maintain a predetermined gap formed between the first and second devices, the spacer extended downward from a body of the work table.

14. The laundry treating system of claim 13, wherein the gap between the first and second treating devices is 25 mm.

15. The laundry treating system of claim 1, wherein the work table comprises a plurality of buffering members provided on a bottom surface of a body of the work table.
